(19) United States
(12) Patent Application Publication
(10) Pub. No.: US 2025/0149796 A1
(43) Pub. Date: May 8, 2025

(54) END-FED ANTENNA

(71) Applicant: Telefonaktiebolaget LM Ericsson (publ), Stockholm (SE)

(72) Inventors: Matthias Arnold, Muelheim an der Ruhr (DE); Philipp Karl Gentner, Wien (AT); Philipp Ponn, Kolbermoor (DE)

(21) Appl. No.: 18/838,406

(22) PCT Filed: Feb. 15, 2022
(86) PCT No.: PCT/EP2022/053612

§ 371 Date: Aug. 14, 2024

(51) Int. Cl. H01Q 9/28; H01Q 5/48; H01Q 9/04; H01Q 19/10; H01Q 21/26

(52) U.S. Cl. CPC H01Q 9/285; H01Q 5/48; H01Q 9/045; H01Q 19/108; H01Q 21/26

(57) ABSTRACT

An antenna system comprising a radiating element configured to emit an electromagnetic wave having a first polarization is described. The antenna system further comprises a feeding structure comprising a first splitter for splitting an electrical signal into a first electrical signal and a second electrical signal. The feeding structure is configured to provide, via first and second electrical couplings, the first and second electrical signals to a first and second end portions of the radiating element, respectively. The second electrical coupling is arranged in the antenna system at least partially on a side of the radiating element which faces towards a reflector of the antenna system. The feeding structure is further configured to shift a phase of the second electrical signal relative to the first electrical signal prior to said providing of the second electrical signal to the second end portion of the radiating element.

### TECHNICAL FIELD

This invention generally relates to an antenna system, in which a first electrical signal is side-fed to a first end portion of a radiating element and a second electrical signal, which is phase-shifted relative to the first electrical signal, is side-fed to a second end portion of the radiating element. The present invention may in particular be incorporated in a base station array antenna radiator element.

### BACKGROUND

Base station antennas according to the state of the art are provided as multiband array antennas. Different antenna elements may hereby be arranged in a multitude of band-individual array columns. Different bands in which multiband antenna arrays according to the state of the art typically operate are low-band (600 MHZ-960 MHz), mid-band (1400 MHZ-2700 MHZ) and high-band (3200 MHZ-4200 MHZ).

FIGS. 1a and 1b show top-views of schematic illustrations of multiband systems according to the state of the art.

In FIG. 1a, the multiband array antenna 100 comprises low-band antenna elements 102 and high-band antenna elements 104. In this example, the low-band antenna elements 102 and high-band antenna elements 104 are arranged in an interleaving manner.

In FIG. 1b, the multiband array antenna 150 also comprises low-band antenna elements 152 and high-band antenna elements 154, whereby the interleaving arrangement of the low-band and high-band antenna elements 152 and 154 is implemented by some of the high-band antenna elements 154 being surrounded by parts of low-band antenna elements 152.

Interleaving designs according to the state of the art are based on a central feeding structure for the antenna elements or a split version in which the cross-polarized low-band antenna elements and the high-band antenna elements cannot be collocated. A drawback according to the interleaving concept of the multiband systems of the state of the art is that the position of the low-band antenna elements needs to be adjusted to the underlying high-band antenna elements. It may be necessary to adjust the position of the antenna elements in order to maintain performance of the individual array.

The feeding structure of the low-band antenna element results in performance degradation of the (underlying) high-band antenna elements and their radiation pattern.

Prior art can be found, for example, in D. A. Buhtiyarov, Novosibirsk State Technical University, Novosibirsk, Russia, 2014 12^{TH} INTERNATIONAL CONFERENCE—APEIE—34006, “Input Impedance of Ends-Fed Dipole Radiator with Prescribed Phase Difference Between Excitation Currents”. In this paper, a complex multiple-arm balun balance unit is used in order to end-feed a dipole radiator.

There is therefore a need for improved antenna systems.

### SUMMARY

According to the present disclosure, there is provided an antenna system comprising a radiating element configured to emit an electromagnetic wave having a first polarization. The antenna system further comprises a feeding structure comprising a first splitter for splitting an electrical signal into a first electrical signal and a second electrical signal. The feeding structure is coupled to the radiating element. The feeding structure is configured to provide, via a first electrical coupling of the feeding structure, the first electrical signal to a first end portion of the radiating element, and provide, via a second electrical coupling of the feeding structure, the second electrical signal to a second end portion of the radiating element. The first end portion is different from the second end portion. The second electrical coupling is arranged in the antenna system at least partially on a side of the radiating element which faces towards a reflector of the antenna system. The feeding structure is further configured to shift a phase of the second electrical signal relative to the first electrical signal prior to said providing of the second electrical signal to the second end portion of the radiating element.

The feeding structure may, in some examples, be distinguished from a feeding network of the antenna system. The feeding network may hereby relate, in some examples, to the antenna feed which may be a cable or conductor which connects the transmitter or receiver with the antenna. For example, in some implementations, the feeding network feeds and distributes the power generated by the radio transmitter to the antenna radiators, especially in an antenna array, which then convert the power in the current to radio waves and radiate in the desired direction. The feeding structure may, in some examples, refer to an electrical coupling which couples, e.g., the splitter to the radiating element and/or which couples, e.g., the splitter with side-feeding PCBs, as will be outlined further below. In some examples, the feeding structure may be one part of the feeding network.

In some examples, the radiating element comprises a dual-polarized cross dipole comprising two dipole arms which are arranged orthogonal with respect to each other. The feeding structure is coupled to a first dipole arm of the two dipole arms, wherein the first end portion of the radiating element comprises a first end portion of the first dipole arm and the second end portion of the radiating element comprises a second end portion of the first dipole arm. The first end portion of the first dipole arm is opposite to the second end portion of the first dipole arm.

In some examples, the feeding structure is configured to shift the phase of the second electrical signal relative to the first electrical signal by 180 degrees or approximately 180 degrees prior to said providing of the second electrical signal to the second end portion of the radiating element.

In some examples, the feeding structure comprises one or more of an analogue phase-shifter and a delay line for shifting the phase of the second electrical signal relative to the first electrical signal prior to said providing of the second electrical signal to the second end portion of the radiating element.

In some examples, the antenna further comprises a first capacitive coupling element, arranged between the first splitter and the first end portion of the radiating element, for providing the first electrical signal from the first splitter to the first end portion of the radiating element. The antenna further comprises a second capacitive coupling element, arranged between the first splitter and the second end portion of the radiating element, for providing the second electrical signal from the first splitter to the second end portion of the radiating element.

In some examples, the first splitter is a T-splitter.

In some examples, the feeding structure comprises a first feeding line which is arranged in the feeding structure to provide the electrical signal to the first splitter. The first feeding line comprises a first winding structure. The first feeding line may, in some examples, electrically couple (or connect) the reflector with an end of the radiating element.

In some examples, the second electrical coupling comprises a second feeding line which couples an output of the first splitter with the second end portion of the radiating element. The second feeding line comprises a second winding structure.

In some examples, the radiating element comprises a third winding structure which couples the first splitter with the first end portion of the radiating element. Additionally or alternatively, a winding structure is provided which is arranged in the feeding structure to provide an electrical signal to a second splitter.

Winding structures may generally be provided in order to block electromagnetic waves (stemming, for example, from high-band radiators underneath low-band radiators) having frequencies above a (predefined) frequency threshold.

In some examples, the first dipole arm is configured to emit the electromagnetic wave having the first polarization and a second dipole arm of the two dipole arms is configured to emit an electromagnetic wave having a second polarization. The first polarization is orthogonal to the second polarization.

In some examples, the feeding structure comprises a second splitter for splitting an electrical signal into a third electrical signal and a fourth electrical signal. The feeding structure is coupled to the second dipole arm. The feeding structure is configured to provide, via a third electrical coupling of the feeding structure, the third electrical signal to a first end portion of the second dipole arm, and provide, via a fourth electrical coupling of the feeding structure, the fourth electrical signal to a second end portion of the second dipole arm. The first end portion of the second dipole arm is opposite to the second end portion of the second dipole arm. The fourth electrical coupling is arranged in the antenna system at least partially on the side of the dual-polarized cross dipole which faces towards the reflector of the antenna system. The feeding structure is further configured to shift a phase of the fourth electrical signal relative to the third electrical signal prior to said providing of the fourth electrical signal to the second end portion of the second dipole arm.

In some examples, the antenna system further comprises a decoupling device arranged at least partially between a first portion of the first dipole arm and a second portion of the second dipole arm.

In some examples, a height of the decoupling device is between 0.1λ and 0.5λ, wherein λ is a wavelength of the electromagnetic waves having the first and second polarizations, respectively.

In some examples, the feeding structure is coupled to respective side contacts of the radiating element for one or both of the first electrical signal and the second electrical signal being feedable to the radiating element from the respective side contacts.

In some examples, the second electrical coupling is sandwiched between a ground structure and the radiating element. In some examples, a shape of the ground structure mates with a shape of the radiating element.

In some examples, a feeding line, in particular the first feeding line as specified above, for providing the electrical signal to the first splitter is sandwiched between two shielding structures. The two shielding structures may in particular shield the feeding line from electromagnetic waves having frequencies above a (predefined) frequency threshold.

In some examples, the feeding line, in particular the first feeding line, extends generally perpendicularly to a direction in which the radiating element extends.

In some examples, the feeding line, in particular the first feeding line, extends generally perpendicularly to a plane in which the two dipole arms extend.

In some examples, the radiating element comprises a triangularly or generally triangularly shaped portion.

In some examples, one or more of a feeding line, in particular the first feeding line as outlined above, for providing the electrical signal to the first splitter, the first electrical coupling, and the second electrical coupling comprise a low-pass filter.

In some examples, the radiating element comprises one or more resonance structures. The resonance structure may, in some examples, block electromagnetic waves having a frequency above a (predefined) frequency threshold.

In some examples, the antenna system further comprises one or more second radiators arranged between a reflector of the antenna system and the radiating element. The one or more second radiators are configured to emit electromagnetic waves having frequencies which are higher than a frequency of the electromagnetic wave emittable by the radiating element.

In some examples, the second electrical coupling is arranged between the radiating element and the reflector in a distance of less than 0.1 of a wavelength of the electromagnetic wave to the radiating element to form a microstrip structure with the radiating element. A ground structure may, in some examples, thus not be required.

### BRIEF DESCRIPTION OF THE DRAWINGS

These and other aspects of the invention will now be further described, by way of example only, with reference to the accompanying figures, wherein like reference numerals refer to like parts, and in which:

FIGS. 1a and b show top-views of schematic illustrations of multiband systems according to the state of the art;

FIGS. 2a and b show a top-view and a cross-sectional side-view, respectively, of a schematic illustration of an antenna system according to some examples of the present disclosure;

FIG. 3 shows a perspective exploded view of a schematic illustration of parts of an antenna system according to some examples of the present disclosure;

FIG. 4 shows a perspective view of a schematic illustration of an antenna system according to some examples of the present disclosure;

FIG. 5 shows a schematic block-diagram of an antenna element according to some examples of the present disclosure; and

FIG. 6 shows a schematic block-diagram of an antenna system according to some examples of the present disclosure.

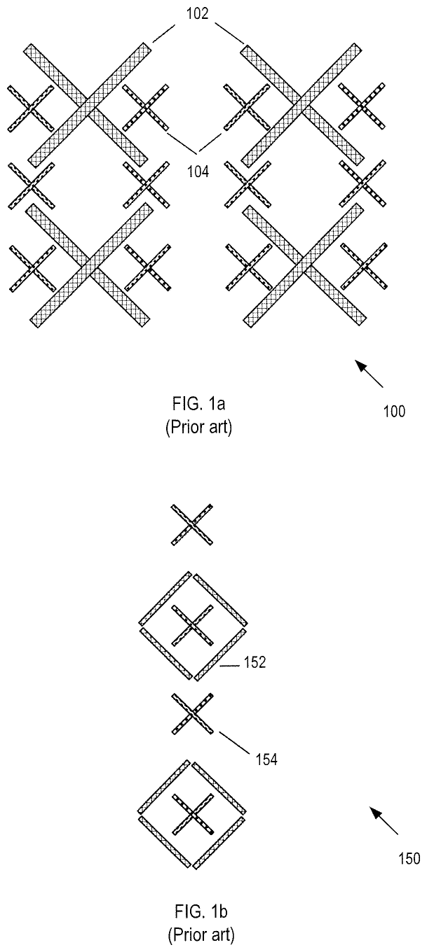

### DETAILED DESCRIPTION

The inventors have realized that in multiband systems according to the state of the art in which an interleaving concept is implemented, the performance of the antenna array may degrade unless the position of, for example, low-band antenna elements are adjusted with respect to the underlying high-band antenna elements. In order to keep performance of the antenna array, an adjustment of the vertical concepts of the low-band antenna elements and the high-band antenna elements to each other may be necessary.

Furthermore, the inventors have realized that the available building space for a low-band antenna element cannot be used in an optimal way in the interleaving concept of the state of the art, which may result in a limited bandwidth of the low-band radiator.

While the following examples relate to end-feeding of a cross-dipole antenna with a 180° phase shifter, the concept of the present disclosure may be applied to other types of antennae.

In some examples of the present disclosure, a two-port system which comprises a four-port two-polarization end-fed (patch) antenna with a six-port feeding structure including one or more 180° phase-shifters is provided. The two-port system may be implemented in a multilayer printed circuit board (PCB). The two-port system is positioned above a reflector and is side-fed, in some examples, by one feeding-PCB for each polarization.

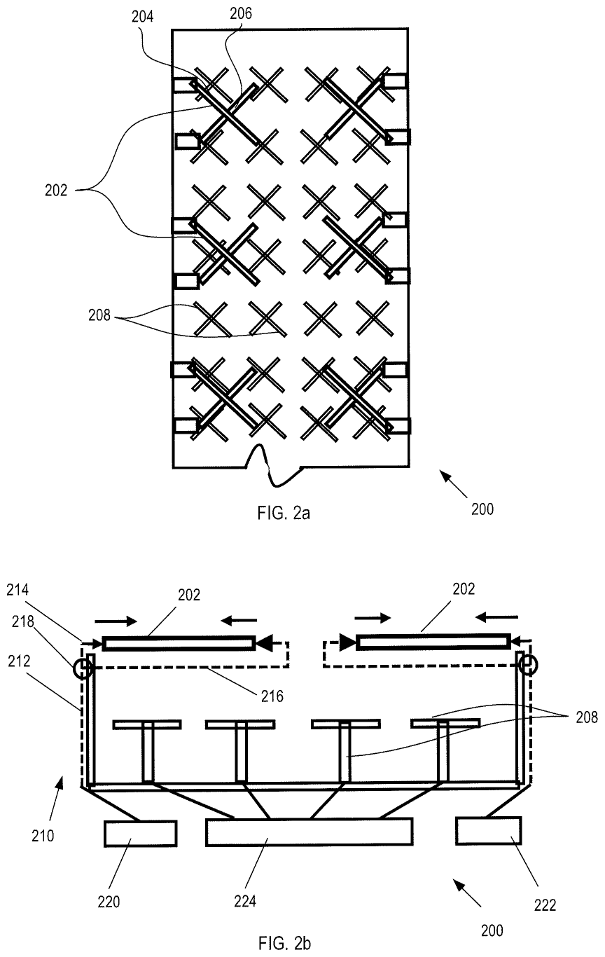

FIGS. 2a and b show a top-view and a cross-sectional side-view, respectively, of a schematic illustration of an antenna system 200 according to some examples of the present disclosure.

In this example, the antenna system 200 comprises a radiating element 202 as a low-band antenna element. The radiating element 202 comprises a first dipole arm 204 and a second dipole arm 206, serving two different orthogonal polarizations. The radiating element 202 is arranged above a plurality of second radiators 208 constituted as high-band antenna elements.

The feeding structure 210 of the antenna system 200 is configured to provide an electrical signal via a feeding line 212 to the radiating element 202. A first end portion of the radiating element 202 is coupled, at the first dipole arm 204, to the feeding structure 210 via a first electrical coupling 214, and a second end portion of the radiating element 202 is coupled, at the other end of the dipole arm 204, to the feeding structure 210 via a second electrical coupling 216.

In order to couple a first electrical signal into the radiating element 202 via the first electrical coupling 214 and a second electrical signal into the radiating element 202 via the second electrical coupling 216, a splitter 218, for example in the form of a T-splitter, may be provided in the feeding structure 210. In this example, a phase-shift of the first electrical signal with respect to the second electrical signal (or vice versa) may be implemented via a delay line provided in the first electrical coupling 214 or the second electrical coupling 216. This phase shift is realized typically as a delay line, but can also be implemented by means of other well-known phase shifting principles, consisting of, for example, couplers or coupled lines or analogue phase shifters. The required phase shift between the couplings 216 and 214 is, in this example, 180°, which is indicated by the opposite arrows at the end of the radiator.

In this example, a feed 220 for the (e.g. low-band) left column and a feed 222 for the (e.g. low-band) right column are provided. The second radiators 208 (which may be high-band radiators) are fed via a feed 224.

In view of this implementation, it may be possible to provide additional radiators (radiating elements) between the before-mentioned two-port system and the reflector without a mechanical conflict with a feeding device positioned at the center of the low-band radiator antenna. In this example, the space below the low-band antenna element is utilized optimally without mechanical conflict for the high-band antenna element array.

The side-feeding in combination with a wideband, dual-polarized cross-dipole antenna may be implemented in other types of radiators, such as, but not limited to loop dipoles, monopole antennae, patch radiators in dual-polarized and single-polarized manner.

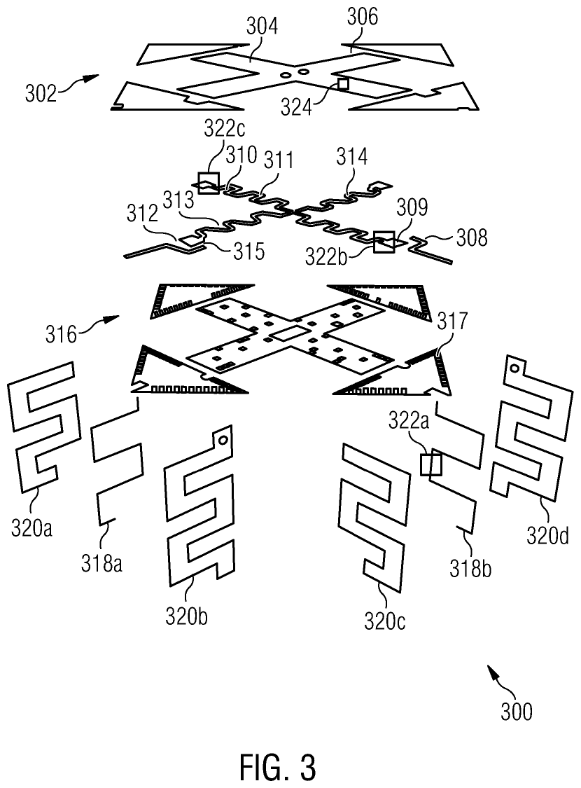

FIG. 3 shows a perspective exploded view of a schematic illustration of parts of an antenna system 300 according to some examples of the present disclosure. The example of FIG. 3 relates to a side-fed two-port system, whereas the two ports serve the two orthogonal polarizations.

In this example, the antenna system 300 comprises a radiating element 302 in the form of a cross-dipole. The dipole arms of the cross-dipole comprise triangularly or generally triangularly shaped end portions for improved broadband radiation. The radiating element 302 is arranged in a third layer of the antenna system 300.

In this example, underneath the first dipole arm 304, a first electrical coupling 308 and a second electrical coupling 310 (with a feeding line 311) are provided (in a second layer of the antenna system 300), so as to feed a first electrical signal to a first end portion of the first dipole arm 304 via the first electrical coupling 308 and to feed a second electrical signal to a second end portion of the first dipole arm 304 via the second electrical coupling 310. Furthermore, in this example, underneath the second dipole arm 306, a third electrical coupling 312 (comprising a feeding line having a winding structure 313, and with a splitter 315 arranged in the feeding structure) and a fourth electrical coupling 314 are provided (also in the second layer of the antenna system 300), so as to feed a third electrical signal to a first end portion of the second dipole arm 306 via the third electrical coupling 312 and to feed a fourth electrical signal to a second end portion of the second dipole arm 306 via the fourth electrical coupling 314. The cross in the middle of both dipole arms in the second layer is arranged as a bridge in a third layer, which is connected with vias to the coupling lines feeding the points where indicated for the third electrical coupling 312 and the fourth electrical coupling 314. Therefore, the signals of the feeding signals for the feeding points for the first and second feeding point (second electrical coupling 310 and first electrical coupling 308) and the third and fourth feeding point (third electrical coupling 312 and fourth electrical coupling 314) remains isolated and decoupled. In this example, a phase difference between the first electrical signal and the second electrical signal is (approximately) 180°. Furthermore, a phase difference between the third electrical signal and the fourth electrical signal is (approximately) 180°. A bridge may be provided in a region where the first to fourth electrical couplings meet so as to electrically isolate the first and second couplings from the third and fourth couplings.

A first splitter 309 may be arranged at an end portion of the first electrical coupling to split an electrical signal which is to be provided to the first electrical coupling and the second electrical coupling for feeding the respective sides of the first dipole arm 304 (according to the schematic shown in FIG. 2b). Furthermore, a second splitter 315 may be arranged at an end portion of the third electrical coupling to split an electrical signal which is to be provided to the third electrical coupling and the fourth electrical coupling for feeding the respective sides of the second dipole arm 306 (according to the schematic shown in FIG. 2b).

It is to be noted that the indicated first to third layers of the antenna system may depend in particular, in some examples, on how the first and third layers are realized. For example, the first and third layers may both be metallic layers between which the first to fourth electrical couplings 308-314 are arranged.

In this example, the first to fourth electrical couplings are sandwiched in a layer (the second layer of the antenna system 300) between the first dipole arm 304 and second dipole arm 306 (which are arranged in the third layer of the antenna system 300) on the one hand and a PCB feeding structure 316 (which is arranged in the first layer of the antenna system 300) on the other hand. One or more through connections with vias or protrusions 317 are, in this example, provided on the PCB feeding structure 316, which mate/align with corresponding, respective components (not shown) on (a bottom side of) the radiating element 302. The third layer (comprising the first dipole arm 304 and the second dipole arm 306) and the first layer (comprising the PCB feeding structure 316) may hereby, in some examples, be identical or nearly identical in terms of their metallization. The bottom layer (first layer) and the upper layer (third layer) may, in some examples, be galvanically connected to each other (in some examples capacitively) and may enclose the feeding lines, to thereby form a sandwiched triplet structure. The metallization of the first and third layers may, in some examples, be (nearly) identical to each other.

The reflector may, in some examples, be electrically conducting and be comprised in the feeding network of the antenna system.

Feeding lines 318a (for feeding port 1) and 318b (for feeding port 2) are provided (in the form of, for example, side-feeding PCBs in the first layer of the antenna system 300) in this example in order to feed electrical signals to the respective dipole arms for the different polarizations (e.g. −45 degrees via feeding line 318a and +45 degrees via feeding line 318b, or vice versa) of the dipole arms.

The feeding lines 318a and 318b are, in this example, sandwiched by shielding structures 320a/b and 320c/d, respectively, so as to provide radiation suppression of radiation, which would otherwise impinge on the feeding lines 318a and 318b. An influence of radiation (in particular of electromagnetic waves having frequencies higher than frequencies emitted by the radiating element 302) on the feeding lines 318a and 318b is further provided based on the feeding lines 318a and 318b and the shielding structures 320a/b and 320c/d having winding shapes. The feeding lines 318a and 318b and the shielding structures 320a/b and 320c/d are arranged generally perpendicularly to a plane in which the radiating element 302 extends.

A ground structure may be provided in the first layer of the antenna system. The ground structure may, in some examples, comprise or be composed of the shielding structures 320a/b and/or 320c/d.

The antenna and feeding structure are, in this example, comprised in different layers of a printed circuit board.

As can be seen from FIG. 3 (and from FIG. 2b), the side-feeding structures are at least partially arranged generally orthogonally with respect to a plane in which the radiating element is arranged.

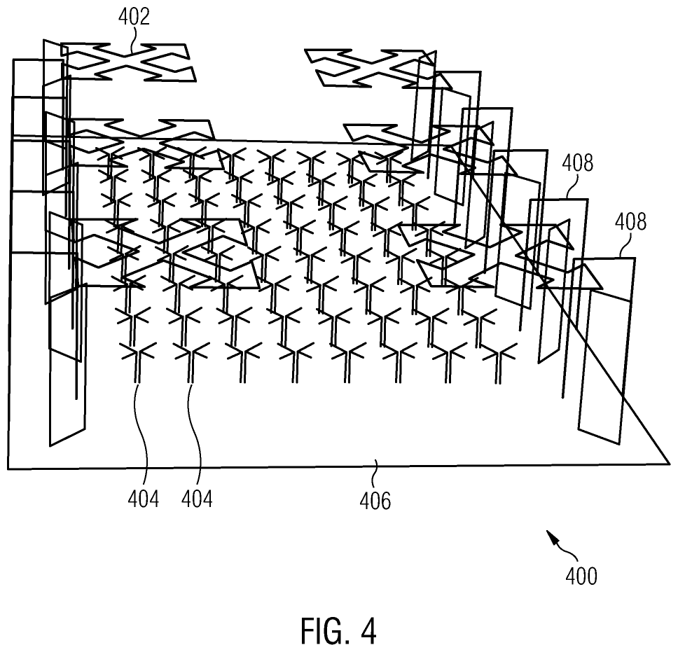

Some elements in FIG. 3 have an at least partially winding (corrugated) structure so as to suppress electromagnetic waves having frequencies above a frequency threshold (in particular electromagnetic waves emitted by radiators arranged underneath the radiating element 302, as will be shown, e.g., in FIG. 4).

In this example, low-pass filters 322a-c are provided to suppress influence of high-band radiators on the electromagnetic wave emitted by the radiating element 302. Furthermore, in this example, one or more resonance structures 324 are arranged on the radiating element 302.

FIG. 4 shows a perspective view of a schematic illustration of an antenna system 400 according to some examples of the present disclosure.

In this example, the antenna system 400 relates to a multiband antenna array consisting of a six-element side-fed two-port system array above a 64-element high-band antenna element array.

Radiating elements 402 are side-fed by a side-fed two-port system as low-band antenna elements. Second radiators 404 are implemented as high-band antenna elements. The radiating elements 402 and the second radiators 404 are arranged on a reflector 406.

In this example, decoupling devices 408 are provided as loops and arranged between the dipole arms of a radiating element 402 and also between different radiating elements 402. As will be appreciated, one or more decoupling devices 408 may only be arranged between different radiating elements 402, and alternatively one or more decoupling devices 408 may only be arranged between the dipole arms of a respective radiating element 402.

In this example, the decoupling devices 408 have a height of 0.1λ to λ, wherein λ is the wavelength of an electromagnetic wave emitted by the radiating elements 402 or the second radiators 404.

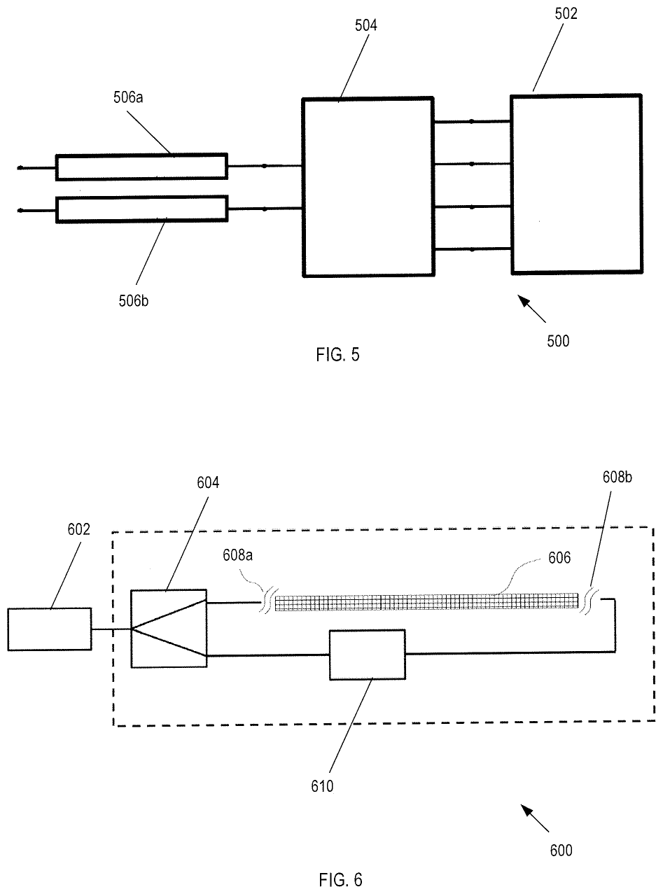

FIG. 5 shows a schematic block-diagram of an antenna element 500 according to some examples of the present disclosure.

In this example, the antenna element 500 relates to a single dual-polarized antenna element.

A four-port two-polarization end-fed (patch) antenna 502 is coupled to a six-port feeding structure 504, which includes 180° phase-shifters. The six-port feeding structure 504 is coupled via two ports to respective side-feeding PCBs 506a and 506b. This six port feeding structure 504 is arranged directly inside a radiator in a sandwiched manner or near to the surface of the radiators, as shown as an example in FIG. 3.

FIG. 6 shows a schematic block-diagram of an antenna system 600 according to some examples of the present disclosure.

In this example, the side-feeding PCB 602 is coupled to a splitter 604, which may be a T-splitter, for splitting an electrical signal into a first electrical signal and a second electrical signal. The first electrical signal is then provided from a first output of the splitter 604 to a first end portion of the end-fed (patch) antenna 606 via a first coupling element 608a. The second electrical signal is provided from a second output of the splitter 604 to a second end portion of the end-fed (patch) antenna 606 via a second coupling element 608b. Before the second electrical signal is provided to the end-fed (patch) antenna 606, its phase is shifted, by a phase shifting device or means (e.g. a delay line) 610, relative to the phase of the first electrical signal, in this example by 180°. To achieve a good radiation characteristic of the radiating element, the magnitude of both signals shall preferably be of equal magnitude.

Therefore, the splitter 604 may, in some examples, have a symmetrical splitting loss of 3 dB.

The phase-shifting of the second electrical signal with respect to the first electrical signal may be provided by one or more of an analogue phase shifter and a delay line between the splitter 604 and the second coupling element 608b.

The antenna system 600 shown in FIG. 6 is used for one polarization. As will be appreciated, if the radiating element or the antennas system emits also an electromagnetic wave having a second polarization, a second system as the one shown in FIG. 6 may be implemented for the second polarization.

As can be seen, implementations according to the present disclosure relate to a novel side-feeding structure, which may be applied in particular, but not exclusively to, cross-dipole antennae.

The feeding structure includes a 180° phase-shifter in particular for a four-port end-fed (patch) antenna to create, in some examples, two polarizations.

In some examples, a side-feeding of a (patch) antenna above a reflector is implemented by a feeding-PCB with a radiation suppressing shape of the feeding line.

It is possible, in particular, to implement additional high-band antenna elements between the two-port system and the reflector without a mechanical conflict of different antenna elements of the antenna system.

No doubt many other effective alternatives will occur to the skilled person. It will be understood that the invention is not limited to the described embodiments and encompasses modifications apparent to those skilled in the art and lying within the scope of the claims append portioned hereto.

1. An antenna system comprising:
a radiating element configured to emit an electromagnetic wave having a first polarization; and
a feeding structure comprising a first splitter for splitting an electrical signal into a first electrical signal and a second electrical signal, wherein the feeding structure is coupled to the radiating element, and wherein the feeding structure is configured to:
provide, via a first electrical coupling of the feeding structure, the first electrical signal to a first end portion of the radiating element,
provide, via a second electrical coupling of the feeding structure, the second electrical signal to a second end portion of the radiating element, wherein the first end portion is different from the second end portion, and wherein the second electrical coupling is arranged in the antenna system at least partially on a side of the radiating element which faces towards a reflector of the antenna system, and
shift a phase of the second electrical signal relative to the first electrical signal prior to said providing of the second electrical signal to the second end portion of the radiating element.

2. An antenna system as claimed in claim 1, wherein the radiating element comprises a dual-polarized cross dipole comprising two dipole arms which are arranged orthogonal with respect to each other, wherein the feeding structure is coupled to a first dipole arm of the two dipole arms, wherein the first end portion of the radiating element comprises a first end portion of the first dipole arm and the second end portion of the radiating element comprises a second end portion of the first dipole arm, and wherein the first end portion of the first dipole arm is opposite to the second end portion of the first dipole arm.

3. An antenna system as claimed in claim 1, wherein the feeding structure is configured to shift the phase of the second electrical signal relative to the first electrical signal by 180 degrees or approximately 180 degrees prior to said providing of the second electrical signal to the second end portion of the radiating element.

4. An antenna system as claimed in claim 1, wherein the feeding structure comprises one or more of an analogue phase-shifter and a delay line for shifting the phase of the second electrical signal relative to the first electrical signal prior to said providing of the second electrical signal to the second end portion of the radiating element.

5. An antenna system as claimed in claim 1, further comprising:
a first capacitive coupling element, arranged between the first splitter and the first end portion of the radiating element, for providing the first electrical signal from the first splitter to the first end portion of the radiating element, and
a second capacitive coupling element, arranged between the first splitter and the second end portion of the radiating element, for providing the second electrical signal from the first splitter to the second end portion of the radiating element.

6. An antenna system as claimed in claim 1, wherein the first splitter is a T-splitter.

7. An antenna system as claimed in claim 1, wherein:
the feeding structure comprises a first feeding line which is arranged in the feeding structure to provide the electrical signal to the first splitter, and wherein the first feeding line comprises a first winding structure; and
the second electrical coupling comprises a second feeding line which couples an output of the first splitter with the second end portion of the radiating element, and wherein the second feeding line comprises a second winding structure.

8. (canceled)

9. An antenna system as claimed in claim 1, wherein the radiating element comprises a third winding structure which couples the first splitter with the first end portion of the radiating element.

10. An antenna system as claimed in claim 2, wherein the first dipole arm is configured to emit the electromagnetic wave having the first polarization and a second dipole arm of the two dipole arms is configured to emit an electromagnetic wave having a second polarization, wherein the first polarization is orthogonal to the second polarization.

11. An antenna system as claimed in claim 10, wherein the feeding structure comprises a second splitter for splitting an electrical signal into a third electrical signal and a fourth electrical signal, wherein the feeding structure is coupled to the second dipole arm, and wherein the feeding structure is configured to:
provide, via a third electrical coupling of the feeding structure, the third electrical signal to a first end portion of the second dipole arm,
provide, via a fourth electrical coupling of the feeding structure, the fourth electrical signal to a second end portion of the second dipole arm, wherein the first end portion of the second dipole arm is opposite to the second end portion of the second dipole arm, and wherein the fourth electrical coupling is arranged in the antenna system at least partially on the side of the dual-polarized cross dipole which faces towards the reflector of the antenna system, and
shift a phase of the fourth electrical signal relative to the third electrical signal prior to said providing of the fourth electrical signal to the second end portion of the second dipole arm.

12. An antenna system as claimed in claim 2, further comprising a decoupling device arranged at least partially between a first portion of the first dipole arm and a second portion of the second dipole arm.

13. An antenna system as claimed in claim 12, wherein a height of the decoupling device is between 0.1λ and 0.5λ, wherein λ is a wavelength of the electromagnetic waves having the first and second polarizations, respectively.

14. (canceled)

15. An antenna system as claimed in claim 1, wherein:
the second electrical coupling is sandwiched between a ground structure and the radiating element; and
a shape of the ground structure mates with a shape of the radiating element.

16. (canceled)

17. An antenna system as claimed in claim 7, wherein the first feeding line for providing the electrical signal to the first splitter is sandwiched between two shielding structures.

18. An antenna system as claimed in claim 17, wherein the feeding line, in particular the first feeding line, extends generally perpendicularly to a direction in which the radiating element extends.

19. (canceled)

20. (canceled)

21. An antenna system as claimed in claim 7, wherein one or more of
the first feeding line for providing the electrical signal to the first splitter, the first electrical coupling, and
the second electrical coupling comprise a low-pass filter.

22. (canceled)

23. An antenna system as claimed in claim 1, further comprising one or more second radiators arranged between a reflector of the antenna system and the radiating element, wherein the one or more second radiators are configured to emit electromagnetic waves having frequencies which are higher than a frequency of the electromagnetic wave emittable by the radiating element.

24. An antenna system as claimed in claim 1, wherein the second electrical coupling is arranged between the radiating element and the reflector in a distance of less than 0.1 of a wavelength of the electromagnetic wave to the radiating element to form a microstrip structure with the radiating element.
